(19) United States
(12) Patent Application Publication
(10) Pub. No.: US 2012/0112087 A1
(43) Pub. Date: May 10, 2012

(54) APPARATUS AND METHOD FOR DETECTING GAMMA-RAY DIRECTION

(75) Inventor: Kazuma Yokoi, Hitachi (JP)

(73) Assignee: HITACHI, LTD., Tokyo (JP)

(21) Appl. No.: 13/381,761

(22) PCT Filed: Jun. 11, 2010
(86) PCT No.: PCT/JP2010/003889

§ 371 Date: Dec. 30, 2011

(30) Foreign Application Priority Data
Jul. 3, 2009 (JP) 2009-158375

(51) Int. Cl. G01T 1/00

(52) U.S. Cl. 250/394; 250/395

(57) ABSTRACT

It is an object of the present invention to allow a gamma-ray-source's existing position direction to be detected using a small-volume gamma-ray detector. A gamma-ray's direction detecting apparatus including a plurality of detection pixels for detecting gamma rays, a memory device for memorizing a correspondence relationship in advance, the correspondence relationship being established for indicating, with respect to predetermined gamma-ray's incoming directions, what kind of actual-measurement frequency data should be acquired using the plurality of detection pixels, and a measurement/calculation unit which measures the gamma-ray's actual-measurement frequency data detected using the plurality of detection pixels, and calculates a gamma-ray's incoming direction by using the actual-measurement frequency data and the correspondence relationship memorized into the memory device.

### TECHNICAL FIELD

The present invention relates to a gamma-ray detector. More specifically, it relates to an apparatus and method for acquiring radiation-source's existing direction information in the apparatus' small volume.

### BACKGROUND ART

The conventional gamma-ray-detector technologies for acquiring the radiation-source's existing direction information include a gamma camera, a Compton camera (Non Patent Literature 1), and an advanced Compton camera (Non Patent Literature 2). There exists the gamma-ray detector which is referred to as the Compton camera, and which is mainly used in the astronomical field. In the Compton camera, however, two-layer detectors are deployed with a clearance set up therebetween in order to implement and obtain the excellent direction resolution. Moreover, the advanced Compton camera (which, hereinafter, will be abbreviated as “ACC”, Non Patent Literature 2) is proposed as a technology for extracting the true radiation-source position from a conical section. The ACC has been found to be successful in implementing localization of the distribution.

### CITATION LIST

### Non Patent Literature

Non Patent Literature 1: Akira Uriya (1999), The Japan Society of Applied Physics, Radiation Subcommittee Bulletin, Radiation, Vol. 25, No. 1, p. 87
Non Patent Literature 2: Takashi Kurihara (2008), Housei University Information Media Education Research Center Research Report, Vol. 21

### SUMMARY OF INVENTION

### Technical Problem

In general, personal-portability-dedicated radiation counters are incapable of acquiring the gamma-ray's incoming direction information.

In the gamma-ray detector which is referred to as the gamma camera, and which is used in the medical field, the incoming direction information is acquired using such appliances as a lead collimator. In the lead collimator, however, the volume and mass of the collimator unit are significantly large. Also, the collimator exhibits its sensitivity only within a certain direction range toward which the collimator's hole is directed. In particular, in the high-energy gamma rays whose energies exceed 200 keV to 500 keV, there occurs a tremendous increase in the thickness, i.e., weight, of such components as the lead needed for the collimator. This drawback causes the collimator's practicability to be lost. Accordingly, in the conventionally-available method where the collimator is used, the problems have existed in the weight and insensitive direction.

There exists the gamma-ray detector which is referred to as the Compton camera, and which is mainly used in the astronomical field. In the Compton camera, however, the two-layer detectors are deployed with a clearance set up therebetween in order to implement and obtain the excellent direction resolution. This configuration generally requires the implementation of a-few-tens-of-centimeter-or-more-sized large volume of the Compton camera, thereby making the Compton camera's sensitivity unsatisfactory in comparison with its large volume. Accordingly, the Compton camera is not suitable for the portable purpose. Also, it is desirable to make a difference in the detector's material properties, i.e., atomic number and density, between the initial-stage detector and the subsequent-stage detector. This difference is made in order to implement a separation between an electron and a photon, i.e., two particles which are caused to occur in the Compton-scattering event. Consequently, it is common not to unify the initial-stage and subsequent-stage detectors into identical and high-sensitivity detectors. Also, the information acquired is a partially conical surface in relation to an arbitrary three-dimensional body, or a line segment of such profile as ellipse in relation to an arbitrary two-dimensional surface. Here, this partially conical surface is formed by a back-projection cone, and is referred to as the conical section. Although this conical section contains the true radiation-source position, it spreads thinly over a wide range. Accordingly, this conical section is not a satisfactory distribution profile.

The advanced Compton camera (which, hereinafter, will be abbreviated as the ACC, Non Patent Literature 2) is proposed as the technology for extracting the true radiation-source position from the conical section. The ACC has been found to be successful in implementing the localization of the distribution. Nevertheless, in order to acquire the direction information about the Compton electron from the Compton electron's travelling track, the ACC is required to use a gas as the initial-stage detector's material. The use of the gas, however, makes the per-volume gamma-ray sensitivity exceedingly unsatisfactory, i.e., about 1/1000 as compared with the case of a solid. Consequently, in the Compton cameras, the problems have existed in the sensitivity and direction resolution in the small volume.

It is an object of the present invention to solve the above-described problems, and to acquire the radiation's incoming direction information without the insensitive direction.

### Solution to Problem

A gamma-ray's direction detecting apparatus including a plurality of detection pixels for detecting gamma rays, a memory device which memorizes a correspondence relationship in advance, the correspondence relationship being established for indicating, with respect to predetermined gamma-ray's incoming directions, what kind of actual-measurement frequency data should be acquired using the plurality of detection pixels, and a measurement/calculation unit which measures the gamma-ray's actual-measurement frequency data detected using the plurality of detection pixels, and calculates a gamma-ray's incoming direction by using the actual-measurement frequency data and the correspondence relationship memorized into the memory device.

### Advantageous Effects of Invention

It becomes possible to acquire the radiation's incoming direction information without the insensitive direction.

### BRIEF DESCRIPTION OF DRAWINGS

FIG. 1 is a diagram for illustrating the overview of an incident-gamma-ray's direction detecting apparatus, and the used-data definition associated therewith.

FIG. 2 is an explanatory diagram for explaining an incoming-direction calculation method where actual-measurement frequency data Di is used.

FIG. 3 is a diagram for illustrating the incoming-direction dependence of an F-position ideal frequency pattern.

FIG. 4 is a diagram for illustrating the incoming-direction dependence of an LH-vector ideal frequency pattern.

FIG. 5 is a diagram for illustrating the incoming-direction dependence of the LH vector where eL is subjected to energy-window division.

FIG. 6 is an explanatory diagram for explaining an incoming-direction estimation method where the maximum likelihood estimation method is used.

FIG. 7 is a diagram for illustrating a sample of the incoming-direction estimation result which is acquired based on the maximum likelihood estimation method where the actual-measurement frequency data Di and the ideal frequency pattern Ei are used.

FIG. 8 is a diagram for illustrating the overview of the incident-gamma-ray's direction detecting apparatus, and the used-data definition (3D).

FIG. 9 is a diagram for illustrating the overview of an interface unit.

### DESCRIPTION OF EMBODIMENTS

Hereinafter, referring to each embodiment, the explanation will be given below concerning the present invention.

Hereinafter, the explanation will be given below regarding a gamma-ray's direction detecting apparatus including a plurality of detection pixels for detecting gamma rays, a memory device for memorizing a correspondence relationship in advance, the correspondence relationship being established for indicating, with respect to predetermined gamma-ray's incoming directions, what kind of actual-measurement frequency data should be acquired using the plurality of detection pixels, and a measurement/calculation unit which measures the gamma-ray's actual-measurement frequency data detected using the plurality of detection pixels, and calculates a gamma-ray's incoming direction by using the actual-measurement frequency data and the correspondence relationship memorized into the memory device.

The schemes for acquiring the gamma-ray's incoming direction information are basically classified into two types, i.e., scheme 1 and scheme 2. The scheme 1 is of a method of assigning, for example by a collimator, a direction-dependent high/low color concentration to the gamma-ray flux which is at the time before it causes the mutual interaction to occur with the detector. The scheme 2 is of a method of observing, for example by an advanced Compton camera, i.e., ACC, the gamma-ray's incoming direction information which remains in a different particle that is created after the gamma-ray's mutual interaction with the detector.

In one of the present embodiments, both of the scheme 1 and the scheme 2 are used simultaneously. Both of them can also be used separately. Concretely, plural pieces of frequency data, i.e., about F position, LH vector, and L position, are used while maintaining the incoming direction information. Here, the frequency data are constituted by plural pieces of actually measured data which are simplified, i.e., lower-dimension-implemented. The F-position frequency data, which corresponds to the scheme 1, is designed to use the high/low color concentration given by the detector itself, i.e., attenuation given by the detection pixels positioned on the nearer side to a certain detection pixel. From the sensitivity's point-of-view, this F-position frequency data can be said to be the most satisfactory data within the scheme 1.

The LH-vector frequency data corresponds to the scheme 2. The LH vector is designed to form the following frequency distribution: Namely, this frequency distribution exhibits an excellent mutual correlation in the incoming direction without being required to make a distinction between the electron and the photon in the Compton scattering. This feature, unlike the Compton camera, permits the detector's material properties to be unified into a high-sensitivity material property. Also, based on a redundancy that two values of x and y are not converted into one value of θ, the LH vector exhibits the following function: Namely, when the LH-vector length is short, information that the angle resolution is unsatisfactory is left. In this way, a preferential treatment is correctly given to the information at the time when the LH-vector length is long. This feature, unlike the Compton camera, allows the detectors to be densely packed.

The L-position frequency data, which is a measurement quantity belonging to the scheme 1 and scheme 2, also depends on the incoming direction. Increasing the types of the measurement quantities employed leads to acquisition of the correct calculation result in a small number of counts.

The maximum likelihood estimation method will be employed and explained as an example of the methodologies for transforming these plural pieces of frequency data into the incoming direction information on the basis of the scheme 1 and scheme 2. This maximum likelihood estimation method is as follows: Namely, an ideal frequency pattern in a large number of counts is acquired in advance for each of all of the candidate directions, i.e., direction parameters. Moreover, the values of the actually-measured-data-realizing realization probabilities, i.e., likelihood degrees, with respect to all of the direction parameters are calculated using the ideal frequency patterns corresponding thereto. Finally, a direction parameter which results in formation of the maximum likelihood degree is selected as the incoming-direction estimation value. The composite estimation based on the three types of frequency data is performed. As a result, the correct estimation in a small number of counts becomes implementable.

Also, consideration is given to the following case: Like the maximum likelihood estimation method, an estimation method employed is based on forward-direction calculations alone, and an inverse calculation, for example a cone generation in the Compton camera, need not be performed. This calculation condition necessitates a wide hypothesized range, thereby bringing about an increase in the necessary calculation amount. Nevertheless, this condition has an advantage of being capable of restoring the spread distribution back to a single point, thereby making a contribution to an enhancement in the direction resolution.

Based on the LH-vector frequency data and the L-position frequency data, the information is acquired from the Compton scattering. Furthermore, the applicable energy is expanded up to an energy area, for example 200 keV to 4 MeV, where the Compton scattering comes to play a main role.

The above-described-method-based direction detecting apparatus can operate without the collimator. Accordingly, the apparatus allows implementation of the small weight and high sensitivity, and also has none of the insensitive direction. Also, the apparatus can operate along with the detectors which are unified into a high-sensitivity material property, and which are packed in a dense manner. Consequently, the apparatus allows acquisition of the high sensitivity in the small volume.

The incoming direction information is acquired by taking advantage of the three types of frequency data simultaneously. Accordingly, the apparatus allows acquisition of the correct estimation result in a smaller number of counts. The acquisition of the correct incoming direction information in the small number of counts is an indirect high-sensitivity implementation.

From the above-described description, it becomes possible to acquire the incoming direction information in the human-portable small volume, with the human-portable small weight, with the high sensitivity, and without the insensitive direction.

Also, as the effects resulting from an interface unit, the polar-coordinate plotting of logarithmic likelihood degrees brings about reliability information on the incoming-direction estimation value. The coincidence with the reality brought about by angle adjustment of the display unit facilitates grasping of the correspondence.

Hereinafter, referring to the drawings, the explanation will be given below concerning the embodiments.

### Embodiment 1

As a first embodiment, the explanation will be given below concerning the estimation of a direction in which the gamma-ray source exists within a substantially flat plane, for example within up and down ±30 degrees, that is to say, the estimation of the gamma-ray's incoming direction.

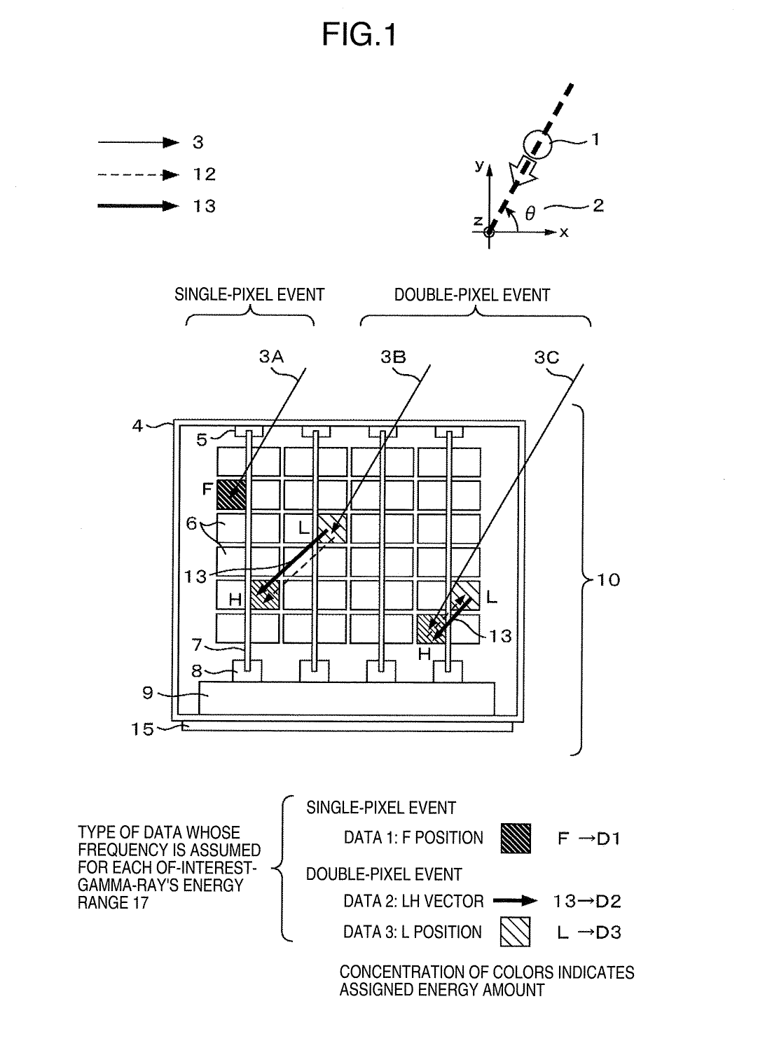

FIG. 1 illustrates the overview of an incident-gamma-ray's direction detecting apparatus and the used-data definition associated therewith. Now, consideration is given to the following case: Namely, a gamma-ray source 1 exists on the x-y plane. Moreover, this gamma-ray source 1 is positioned sufficiently far away from the incident-gamma-ray's direction detecting apparatus 10, for example 10-times-or-more distance away therefrom as compared with the sensitive-portion width of the detector 10. Accordingly, it is allowable that the incoming directions 2, which is equal to a longitude direction θ, of a plurality of incident gamma rays 3 emitted from the gamma-ray source 1 are regarded as being one and the same incoming direction. The representative value of the sensitive-portion width of the detector 10 is assumed to be 3 cm to 10 cm. Also, the type of the incident gamma rays 3, whose direction determination is to be performed, is determined in advance. Furthermore, e.g., a ±2%-width window of the corresponding total absorption energy is assumed to be an of-interest-gamma-ray's energy range 17. The case where the gamma-ray's type is not determined in advance will be described later. It is also allowable to address a plurality of of-interest-gamma-ray's energy ranges 17 simultaneously.

The detector 10 is constituted from a plurality of detection pixels 6 which are implemented on a substrate 7. This substrate 7 is supported by a chassis 4, supporting members 5, and connectors 8. Each radiation-detecting detection pixel 6 may be whatever of such elements as semiconductor detector, “scintillator+photodiode”, “scintillator+avalanche photodiode”, and “scintillator+multi-pixel avalanche photodiode”. It is desirable, however, that the effective atomic number and mass density of each detection pixel 6 be large to some extent, for example “effective atomic number>30”, “mass density>5 g/cm³”. This condition is desirable in order to detect the high-energy gamma rays 3 and Compton-scattering photons 12 corresponding thereto. It is assumed that, although not illustrated, there properly exist such components as an electrode member for performing bias-voltage application and signal acquisition.

Also, each detection pixel 6 may be a single element in the z direction. Otherwise, in order to obtain an excellent energy resolution, each detection pixel 6 may also be a device which outputs z-direction-projected, i.e., z-direction-neglected, information by dividing the detection element in the z direction, and making the element smaller and smaller down into a proper size. The lower-limit of the single element size is specified by a necessity that the lower-limit is sufficiently larger, for example 5 times or more, as compared with the electron's travelling range, for example 100 μm. The element size's upper-limit is specified by the above-described energy-resolution performance. In addition thereto, the element size's upper-limit is also specified by the following necessity: Namely, the upper-limit is small, for example 2 times or less of the mean free path, in such an extent as not stopping the gamma ray 3 too much in one layer of each detection pixel 6. The mean free path for the incident gamma ray 3, which depends on the type of each detection pixel 6 and the energy of the gamma ray 3, is equal to, e.g., 20 mm. From these numerical conditions, the appropriate representative size, which need not be a cube, of each detection pixel 6 is set at 0.5 mm to 40 mm, or preferably, about 1 mm to 20 mm. Also, there exist measurement methodologies where the space resolution is smaller than the size of the base material of each detection pixel 6, such as charge division method and partition of only an electrode of the semiconductor detector. In this case, it is all right only to read the space-resolution size or binning size as each detection pixel 6.

A measurement/calculation unit 9 provides each detection pixel 6 with a performance for allowing an energy amount e, which is assigned into the inside of each detection pixel 6, to be recorded and communicated in accompaniment with the point-in-time t and the x and y coordinates at the time of this assignment. This performance is the common radiation-detecting technology that uses such devices as charge amplifier, shaping amplifier, and peak hold. In the case of the semiconductor detector and avalanche photodiode, such devices as high-voltage power-supply are also included. Also, this measurement/calculation unit 9 is designed to perform such calculations as the one in the maximum likelihood estimation method, which will be described later.

As the common performance of the detector, a single-body detection pixel 6 is incapable of distinguishing and identifying the incoming direction 2 of the incident gamma rays 3. Now, in association with the time resolution, consideration is given to the following case: Namely, as the common performance, the time resolution is equal to about a-few-nanosecond to a-few-microsecond value. This value is satisfactory enough with respect to the inverse of the count ratio, but is unsatisfactory in such an extent as not being capable of resolving the photon's travelling time difference, i.e. a few tens of picoseconds, inside the detector 10. Two or more measurements which occur in accordance with a time difference smaller than this time resolution are expressed as being “simultaneous”.

Recognizing the incoming direction 2 of the incident gamma rays 3 requires some kind of measurement values which change in dependence with a change in the incoming direction 2. These measurement values will be described hereinafter.

As is the case with the other electromagnetic waves such as visible light, the gamma ray is also caused to lose the number of its photons exponentially by interactions which occur when the gamma ray passes through a physical substance. The main interactions by the gamma ray with respect to a physical substance are the photoelectric effect, the Compton scattering, and the electron-pair creation. When the effective atomic number Z of each detection pixel 6 is equal to about 40, the gamma-ray's energy ranges where the photoelectric effect, the Compton scattering, and the electron-pair creation come to play a main role respectively are equal to about 200 keV or lower, about 200 keV to 8 MeV, and about 8 MeV or higher, respectively (, although these energy ranges depend on the effective atomic number specified). It is quite unusual that the position of the targeted gamma-ray source 1 is unknown. Accordingly, if the gamma-ray source 1 is restricted to a radioisotope, the upper-limit of the gamma ray emitted therefrom is equal to about 2 MeV usually, or about 4 MeV even in the case of a low-radiation-ratio ingredient. Consequently, the electron-pair creation is of no importance.

In the photoelectric effect, like the incident gamma ray 3A, the following probability is significant: Namely, the total energy of the incident gamma ray 3 is assigned into the proximity, for example within a 1-mm area, of a certain single detection pixel 6. Moreover, the net energy of the incident gamma ray 3 as it is is detected in this single detection pixel 6. Conversely, consideration is given to the following case: Namely, an energy-assigning event, which falls into the of-interest-gamma-ray's energy range 17, for example 1. 33 MeV±2%, is detected in a certain single detection pixel 6. In this case, this energy-assigning event is defined as a single-pixel event. At this time, the main constituent of this single-pixel event becomes a constituent resulting from the photoelectric effect. The other constituents include such situations as a case where the scattered photons by the Compton scattering are re-absorbed into a close proximity to the detection pixel 6. The position at which this single-pixel event has occurred is defined as a total-energy absorption position F. Furthermore, F-position actual-measurement frequency data D1, which is acquired by assuming the frequency distribution of this total-energy absorption position F, is the first type of the actual-measurement frequency data used for the determination of the incoming direction 2 of the incident gamma rays 3. It is indicated by using a notation D1 [x] [y] that the bin partition of D1 depends on indexes x and y. It is also assumed that the coordinates and the indexes are in a one-to-one correspondence relationship, and can be appropriately converted to each other. When the gamma-ray source 1 is a radioisotope, this frequency, i.e. a count, becomes a Poisson-distribution-following measurement quantity.

In the Compton scattering, a single incident gamma ray 3 gives rise to the generation of two particles, i.e., the Compton-scattering photon 12 and a (not-illustrated) Compton-scattering electron. Typically, the electron's travelling range is smaller than the size of each detection pixel 6. As a consequence, the energy of the Compton-scattering electron is assigned into the detection pixel 6 where the Compton scattering has occurred. Meanwhile, the energy of the Compton-scattering photon 12, which forms the pair with the electron, is assigned into another detection pixel 6.

The following energy-assigning event is defined as a double-pixel event: Namely, an energy assignment simultaneously occurs into certain two detection pixels 6. Moreover, the sum total of the resultant two energy assignments falls into the of-interest-gamma-ray's energy range 17, for example 1. 33 MeV±2%. At this time, the main constituent of this double-pixel event becomes a constituent resulting from the Compton scattering. The other constituents result from a case where the multiple Compton scattering has occurred, and an escape of electromagnetic waves, such as characteristic X rays, other than the Compton-scattering photon. The execution of this simultaneous judgment and the judgment inside or outside the of-interest-gamma-ray's energy range 17 makes it possible to identify and remove scattered radiations from the outside, i.e., noise constituents.

Of the double-pixel event, attention is focused on its main constituent resulting from the Compton scattering. At this time, the energies which will be distributed to the Compton-scattering electron and the Compton-scattering photon 12 are given by the following (Expressions 1), respectively: Here, these energies are given as functions of an angle α of the Compton-scattering photon 12 with the incident gamma ray 3 selected as the angle criterion:

$$\begin{matrix}[ MATH 1 ] & \\ {E}_{p} = \frac{{E}_{0}}{1 + \frac{{E}_{0}}{511 keV} ( 1 - cos α )} \\ {E}_{e} = {E}_{0} - {E}_{p} & ( Expressions 1 )\end{matrix}$$

E₀: incident photon's energy
Eₚ: Compton-scattering photon's energy
Eₑ: Compton-scattering electron's energy

The angle formed by the pair of 3 and 12 in FIG. 1 is not α, but an angle which is obtained by projecting a on the x-y plane. The incident gamma ray 3B is an example in a case where this angle is small. In this case, the energy-assigned amount on the electron side is low, and the energy-assigned amount on the photon side is high. Meanwhile, the incident gamma ray 3C is an example in a case where this angle is large. In this case, the energy-assigned amounts are inverted, i.e., the energy-assigned amount on the electron side is high, and the energy-assigned amount on the photon side is low. This phenomenon shows the following fact: Namely, at the time of the actual measurement, excluding a case where the incoming direction 2 has been known already, of the two detection pixels 6 into which the energy assignments have occurred, it is impossible to identify which detection pixel has received the energy assignment performed by the electron, and which detection pixel has received the energy assignment performed by the photon.

In substitution for the above-described unrecognizable positions of the electron and the photon, two sets of (x, y, e), i.e., raw data other than the data at the point-in-time of the double-pixel event, are characterized by the large-or-small relationship of these assigned energies e. Accordingly, the lower-energy set and the higher-energy set will be referred to as

“L” and “H”, respectively. Also, their respective (x, y, e) will be referred to as “(xL, yL, eL)” and “(xH, yH, eH)”, respectively. Now, consideration is given to the following idea: Namely, the relative coordinate (xH-xL, yH-yL) ranging from the L position to the H position is defined as an LH vector 13, and this LH vector 13 will be used for the determination of the incoming direction 2. The ray 3B and the ray 3C indicate the case where the LH vector 13 coincides with the travelling path of the Compton-scattering photon 12, and the case where the LH vector 13 becomes inverted to this travelling path, respectively. When a is approximately equal to 180 degrees, the LH vector 13 becomes inverted onto the 0-degrees-side. This fact shows that the LH vector 13 has a property of being likely to be biased onto the 0-degrees-side. Namely, the newly-defined LH vector 13 can be expected to exhibit an excellent correlation in the incoming direction 2.

The corresponding LH-vector actual-measurement frequency data D2 at the time of the double-pixel event is defined as the second type of the actual-measurement frequency data used for the determination of the incoming direction 2. Also, considering that (xL, yL) is present within the raw data as an unused independent constituent, it can be useful to define (xL, yL) as the L position, and to use the corresponding L-position actual-measurement frequency data D3 as the third type. The LH-vector actual-measurement frequency data D2 and the L-position actual-measurement frequency data D3 may be divided by applying an energy-window processing to the lower energy eL. The summation of eL and eH is so selected as to fall into the of-interest-gamma-ray's energy range 17. Accordingly, eH is not independent, and thus need not be subjected to the energy-window processing. At this time, the bin range of D2 and that of D3 are represented as D2 [w] [xRel] [yRel] and D3 [w] [x] [y], respectively. Here, and w mean the relative coordinate and the energy-window number, respectively. As is the case with D1, the count numbers of D2 and D3 also become the Poisson distributions, which makes it easy to deal with the count numbers at the subsequent stage. Incidentally, (xL, yL, xH, yH), i.e., position information on the large-or-small relationship of the energies of the LH-vector actual-measurement frequency data D2, can also be used as actual-measurement frequency data D4. The generic name for these pieces of actual-measurement frequency data is given as Di. The actual-measurement frequency data Di are stored into a storage 22, which forms a partial unit of the measurement/calculation unit 9.

Consideration is given to an operation where the size of each detection pixel 6 is made smaller and smaller, for example 1 mm or smaller, while maintaining the high energy, for example 2 MeV or higher. This operation makes it common that energy assignments into a plurality of detection pixels 6 occur in each of proximities to the mutual-interaction position of the incident gamma ray 3 and that of the Compton-scattering photon 12. Even in a case like this, as long as the detection pixels 6 can be regarded as being localized into two groups which are apart at a certain-constant, for example 3 mm-or-less distance, the use of the total energy and representative position of the respective groups makes it possible to fit this case into the above-described format.

The detector 10 includes an interface panel 15 on its rear surface, thereby making it possible to perform the display and input/output of information.

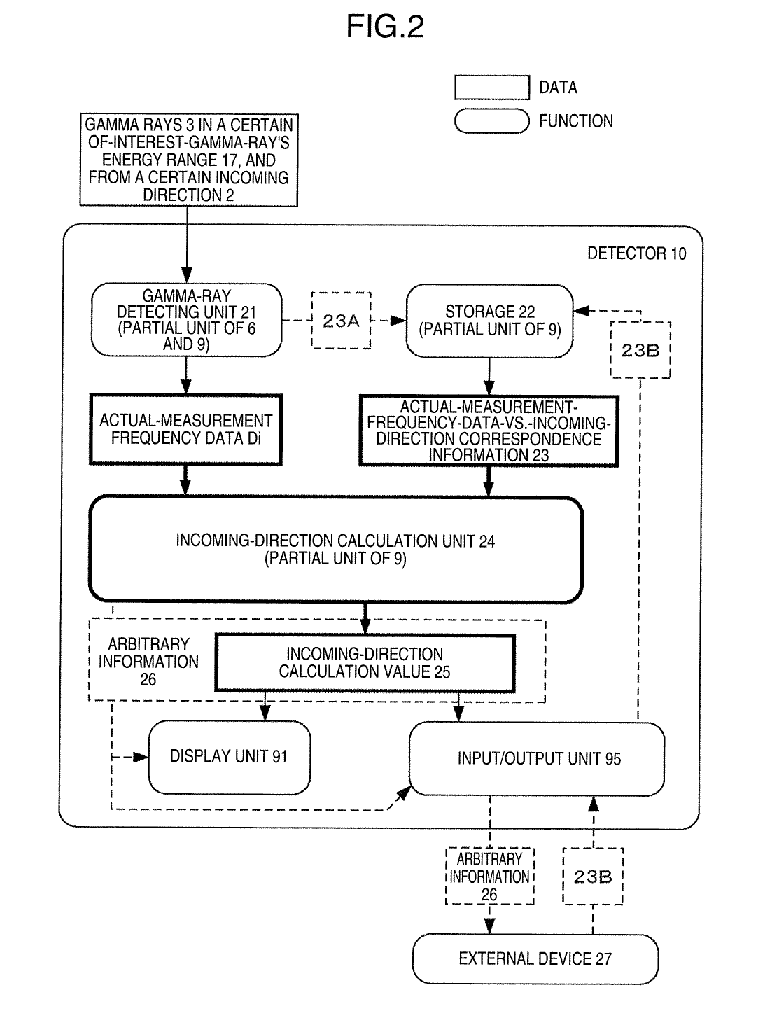

FIG. 2 illustrates an incoming-direction calculation method where the actual-measurement frequency data Di is used.

Incidentally, calculation processing for calculating functions illustrated in the drawing can be carried out using such devices as a computer including a memory unit and a CPU. Also, such devices as processing units as the functions possessed by the apparatus are program modules. Accordingly, the respective functions can be carried out by causing the computer to read and execute the program modules. Also, the respective functions are made executable by causing the computer to read a memory medium which stores the program modules therein.

Consideration is given to a case where, with respect to a certain of-interest-gamma-ray's energy range 17, a group of the incident gamma rays 3 enters the detector 10 from a certain incoming direction 2, i.e. “0”. At this time, a gamma-ray detecting unit 21 inside the detector 10 converts the group of the incident gamma rays 3 into the actual-measurement frequency data Di defined in FIG. 1. The gamma-ray detecting unit 21 includes a group of the detection pixels 6 and a partial unit, such as a charge amplifier, of the measurement/calculation unit 9.

Here, the actual-measurement frequency data Di are acquired in a manner of being dependent on the incoming direction 2. This condition makes it possible to investigate in advance a correspondence relationship which is established for indicating what kind of actual-measurement frequency data Di should be acquired with respect to which incoming direction 2 of all of the incoming directions 2. This correspondence relationship will be referred to as “actual-measurement-frequency-data-vs.-incoming-direction correspondence information 23”. This correspondence information 23 is basically a multi-value function Di=Function (θ), or more directly, a multi-argument function θ=Function⁻¹(Di). Otherwise, the correspondence information 23 may be a multi-stage function relationship such as Di=Function (some (θ)). A further modified example which uses an ideal frequency pattern Ei for describing a statistical physical phenomenon is a second embodiment. The actual-measurement-frequency-data-vs.-incoming-direction correspondence information 23 may be information, i.e. 23A, which is acquired based on the actual measurement made by the gamma-ray detecting unit 21 itself of the detector 10. Otherwise, the correspondence information 23 may be information, for example a computer simulation result, which is transferred from an external device 27, for example a PC, i.e. 23B. The correspondence information 23 is stored into the storage 22, which forms the partial unit of the measurement/calculation unit 9. The storage 22, which is an information-memorizing memory device, may also be a CPU-accessible main memory device.

The existence of the correspondence information 23 like this allows implementation of a calculation for permitting certain actual-measurement frequency data Di to be restored back to the incoming direction 2. If the correspondence information 23 has been already acquired as being θ=Function⁻¹ (Di), an incoming-direction calculation value 25 can be acquired therefrom directly. If the correspondence information 23 has been already acquired as being Di=Function (θ), the calculation value 25 can be acquired by searching for θ with which Di coincides. A unit which makes this calculation is selected to be an incoming-direction calculation unit 24, which is a partial unit of the measurement/calculation unit 9. Actually, the actual-measurement frequency data Di are indirectly inputted into the incoming-direction calculation unit 24 via the storage 22. This, fact, however, is omitted in FIG. 2 for implementation of the easy-to-understand illustration, i.e. a contrast. Also, the actual-measurement-frequency-data-vs.-incoming-direction correspondence information 23 need not be associated with all of the directions 2. Namely, the correspondence information 23 may be associated with some of the directions 2, or can be associated with a plurality of predetermined directions.

The incoming-direction calculation value 25 acquired is transmitted to the interface panel 15 on the detector 10′s rear surface by a display unit 91, thereby being transmitted to the user. Also, arbitrary information 26 including the incoming-direction calculation value 25 and the actual-measurement frequency data Di may be transmitted to the external device 27 via the display unit 91 and an input/output unit 95.

In the above-described example, the explanation has been given using the actual-measurement frequency data Di. The incoming direction of the radiation, however, can be calculated using one or more whatever data of the D1, D2, and D3 actual-measurement frequency data Di. Also, the position at which the single-pixel event has occurred is defined as the total-energy absorption position F. Then, the F-position actual-measurement frequency data D1 obtained by assuming the frequency distribution of this position F is used for the determination of the incoming direction. In this case, it can be made unnecessary to use the measurement data on a point-in-time t for information on the simultaneousness of a plurality of mutual interactions.

In this way, there is provided the radiation's direction detecting apparatus including the plurality of detection pixels for detecting the radiations, the memory device for memorizing the correspondence relationship in advance, the correspondence relationship being established for indicating, with respect to the predetermined radiation's incoming directions, what kind of actual-measurement frequency data should be acquired using the plurality of detection pixels, and the measurement/calculation unit which measures the radiation's actual-measurement frequency data detected using the plurality of detection pixels, and calculating the radiation's incoming direction by using the actual-measurement frequency data and the correspondence relationship memorized into the memory device. This radiation's direction detecting apparatus makes it possible to acquire the radiation's incoming direction information in the human-portable small volume, with the human-portable small weight, with the high sensitivity, and without the insensitive direction.

Also, there is provided the radiation's direction detecting method, including the steps of the radiation's direction detecting apparatus's detecting the radiations using the plurality of detection pixels; and measuring the radiation's actual-measurement frequency data detected using the plurality of detection pixels, and calculating the radiation's incoming direction by using the actual-measurement frequency data and the correspondence relationship memorized into the memory device, the radiation's direction detecting apparatus being so designed as to memorize the correspondence relationship in advance, the correspondence relationship being established for indicating, with respect to the predetermined radiation's incoming directions, what kind of actual-measurement frequency data should be acquired using the plurality of detection pixels for detecting the radiations. This radiation's direction detecting method makes it possible to acquire the radiation's incoming direction information in the human-portable small volume, with the human-portable small weight, with the high sensitivity, and without the insensitive direction.

Also, there is provided the radiation's direction detecting method of calculating the radiation's incoming direction by using, as the actual-measurement frequency data, a combination of at least two or more whatever frequency data of frequency data on a total-energy absorption position in a single-pixel event, frequency data on inter-two-points relative positions ranked by an energy-assigned amount into each detection pixel in a double-pixel event, and frequency data on a single-point position ranked by the energy-assigned amount into each detection pixel in the double-pixel event. This radiation's direction detecting method allows implementation of the correct estimation in a small number of counts.

### Embodiment 2

As a second embodiment, the explanation will be given below concerning an example which employs the maximum likelihood estimation method, i.e., a preferable example to be used in the incoming-direction calculation unit 24. The ideal frequency pattern Ei is defined as the actual-measurement-frequency-data-vs.-incoming-direction correspondence information 23 which is suitable for the maximum likelihood estimation method, and which should be prepared in advance. Consideration is given to special actual-measurement frequency data D1 to D3 which correspond to a case where sufficiently-large-number-of-times irradiations are performed for each of-interest-gamma-ray's energy range 17 and from all of the incoming directions 2, i.e. “θ”, which are obtained by dividing 360 degrees, for example by a 15-degrees-increment). These special actual-measurement frequency data D1 to D3 are defined and employed as the ideal frequency pattern E1 to E3, whose generic name is given as Ei. The sufficiently-large-number-of-times irradiations are so assumed as to give rise to occurrence of the counts, for example 10000 or more counts, at which the ratio between the irradiation number-of-times and the frequency converges into a substantially constant value in the bin which forms the representative structure portion, i.e. which gives rise to the occurrence of the large number of counts. The sufficiently-large-number-of-times irradiations may be performed using the actual device of the detector 10. This case is equivalent to 23A. Otherwise, the irradiations may be prepared based on a computer simulation, or a computer random-number simulation by modeling the implementation structure of the detector 10 on the computer. This case is equivalent to 23B. If the actual device of the detector 10 has an individual difference in such performances as the sensitivity due to such causes as dimension error, it is desirable to make the actual measurement using ten units of respective detectors 10. The creation of the ideal frequency pattern Ei is performed in each individual detector 10 at a single time and within a range where such factors as time-elapsed change in the performances are negligible. As long as this condition is satisfied, the ideal frequency pattern Ei created are available in a plurality of times of measurements thereinafter.

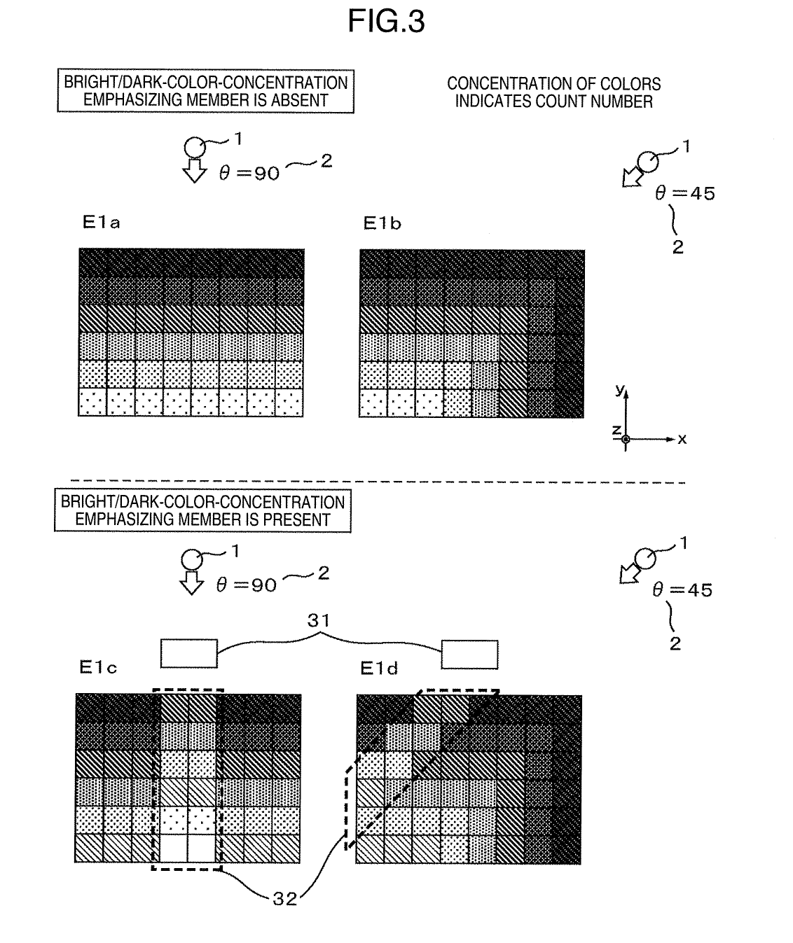

FIG. 3 illustrates the incoming-direction dependence of the F-position ideal frequency pattern E1. The F-position ideal frequency pattern E1 and the F-position actual-measurement frequency data D1 are occurrence frequency distributions of the single-pixel event, i.e., the frequency distributions of the occurrence of the F position, in each detection pixel 6 inside the detector 10 (not illustrated). As schematic diagrams of the F-position ideal frequency pattern E1, FIG. 3 illustrates E1a, which is obtained when the incoming direction 2 is equal to 90 degrees, and E1b, which is obtained when the incoming direction 2 is equal to 45 degrees. As illustrated in the diagrams, the F-position ideal frequency pattern E1 exhibits a large number of counts on the side where the gamma-ray source 1 exists, and a small number of counts on the side opposite thereto. This phenomenon is attributed to a physical property of the gamma-ray flux, i.e. the plurality of gamma rays 3, that the gamma-ray flux attenuates exponentially when it passes through a physical substance.

It is allowable to set up a bright/dark-color-concentration emphasizing member 31 into the inside, or the outside whose relative position is fixed, of the chassis 4 constituting the detector 10. This emphasizing member 31 causes a small-number-of-counts portion 32 to be formed by the effect of its shadow, thereby allowing an enforcement of the correlation of the F-position ideal frequency pattern E1 to the incoming direction 2. This set up of the emphasizing member 31 gives rise to an increase in the weight, and results in a demerit that the sensitivity lowers in the incoming direction 2 in which Nevertheless, this set up makes it easy to distinguish a proximate direction to the incoming direction 2. This feature is especially useful for causing the 200-keV-or-lower low-energy gamma rays, with which the Compton scattering does not become the main mutual interaction, to have the resolution in the incoming direction 2.

The material suitable for the bright/dark-color-concentration emphasizing member 31 is a material which is produced by forming large-atomic-number and high-mass-density lead or tungsten into a-few-mm-square, i.e. whose shielding rate is equal to, e.g., a few tens of %, -or-more size. If the shadow-originated small-number-of-counts portion 32 is suppressed down to the one-second-or-third, which, in FIG. 3 below, is equal to 25%= 2/8 at the time of 90 degrees, of the total sensitive volume, the sensitivity lowering is suppressed down to, e.g., about 10% by being multiplied by a few tens of %, i.e., the shielding rate in the shadow. This result significantly differs from the collimator which has no sensitivity, i.e. the sensitivity lowering is substantially equal to 100%, with respect to a certain direction. The bright/dark-color-concentration emphasizing member 31 may be deployed in a manner of being surrounded by a plurality of detection pixels 6. Otherwise, a plurality of bright/dark-color-concentration emphasizing members 31 may be prepared.

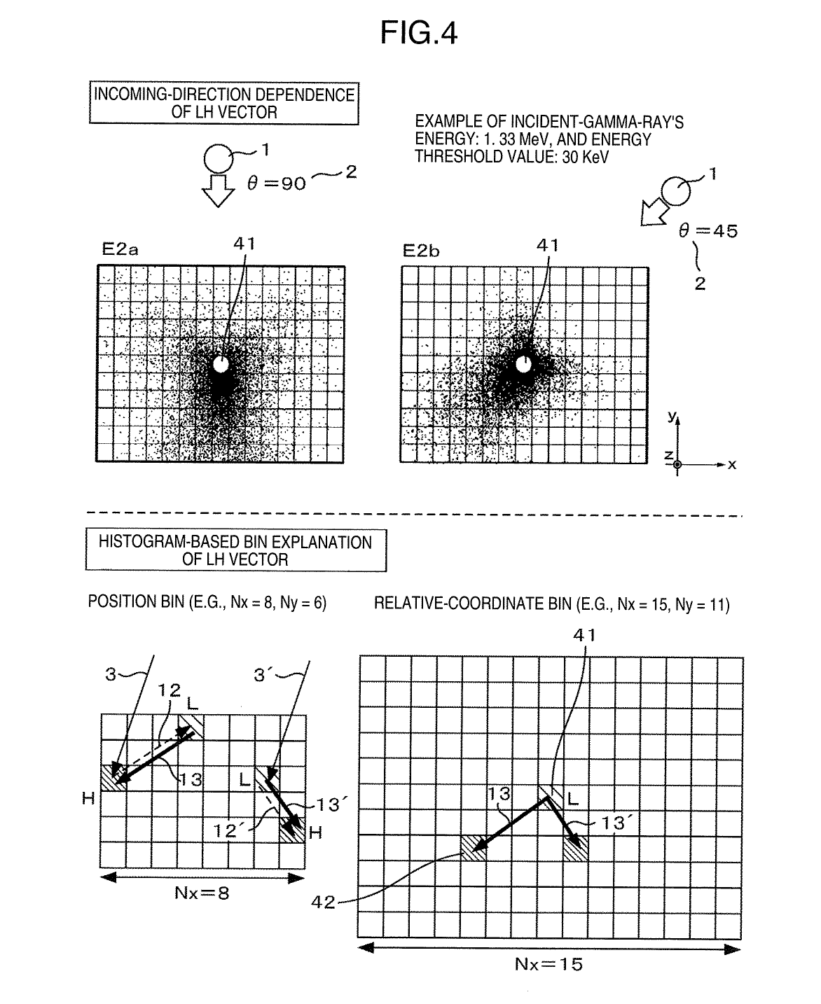

FIG. 4 illustrates the incoming-direction dependence of the LH-vector ideal frequency pattern E2. The energy of the gamma ray used is equal to 1.33 MeV. Moreover, the distributions within a range of eL>30 keV are illustrated, taking into consideration the fact that there exists a lower-limit in the energy detectable by an actual detector. As the LH-vector ideal frequency pattern E2, FIG. 4 illustrates E2a, which is obtained when the incoming direction 2 is equal to θ=90 degrees, and E2b, which is obtained when the incoming direction 2 is equal to θ=45 degrees. Here, as the explanation of the principle, the explanation will be given regarding the following case: Namely, the extraction of a one-time constituent of the Compton scattering, i.e., the main constituent, is performed using the detector whose space resolution is unlimited. Accordingly, the bin-size-or-smaller structure is also seen in these drawings. Under an appropriate detector's geometry, even if the other physical phenomena, such as plural times of Compton scatterings, characteristic-X-ray escape, electron escape, and detector's finite space resolution, are added, the LH-vector ideal frequency pattern E2 is acquired which exhibits an excellent correlation with the incoming direction 2 (not illustrated).

A single LH vector 13 is the relative-coordinate vector of the H position relative to an L position which is selected and defined as the start point. In the case of the position-bin size illustrated in FIG. 4 below, i.e., when the numbers of the detection pixels 6 are equal to Nx=8 and Ny=6, the bin numbers of the relative coordinates to which the plurality of LH vectors 13 belong become equal to Nx=15 (=8×2−1) and Ny=11 (=6×2−1). Moreover, L-position start point 41 is deployed at the center of the bin numbers. Also, a single count is assigned with respect to a bin which corresponds to each of LH-vector end points 42 whose start points are aligned into an identical point. Furthermore, even if the Compton scattering has occurred, if both the Compton-scattering electron and the Compton-scattering photon have assigned their energies into one and the same detection pixel 6, these energy-assigning events turn out to be the single-pixel event. Accordingly, at this time, the count of the L-position start point 41 is equal to zero.

In this way, the following fact is shown: Namely, the LH-vector ideal frequency patterns E2 and E2b, which are acquired as a result of plotting the plurality of LH vectors 13, exhibit the significant dependence on the change in the incoming direction 2. An example of this dependence is that E2 and E2b have the small-number-of-counts portion on the side of the gamma-ray source 1, and the large-number-of-counts portion on the side opposite thereto. Namely, it can be expected that the employment of the frequency distributions of the LH vectors as the data will be found to be useful for the determination of the incoming direction 2. Now, consideration is given to the concept of “HL vector”, where, conversely, the H position is selected and defined as the start point. At this time, the same result as the LH vector can be obtained as the correlation only to find that its direction is opposite to the incoming direction 2. Accordingly, the HL vector is also usable. It is redundant to continue to retain the two-dimensional information of x and y in order to determine the one-dimensional information of θ. Meanwhile, if a simple transformation from x and y to θ, such as θ=arctan (y/x), is straightforwardly performed in each single count, the satisfactory θ distribution cannot be obtained. This is because the angle information is extremely unsatisfactory, for example in the eight approximate pixels, the direction can only be separated into 45 degrees, in a proximity to the L-position start point 41 where a large number of counts exist. The retention of the x and y information, however, makes it possible to make the distinction between the pixels close to the L-position start point 41 and the ones distant therefrom. Also, it has become a characteristic element of the frequency distributions that the frequency distributions attenuate exponentially in the path-length directions, i.e. radial directions from the L-position start point 41, as well, and along the mean free paths which differ from each other on each angle basis.

Also, the L-position ideal frequency pattern E3, which corresponds to the third data, has been found to exhibit a frequency distribution which is similar to the one of E1, i.e. it has the large-number-of-counts portion on the side of the gamma-ray source 1, and the small-number-of-counts portion on the side opposite thereto. Moreover, E3 has been found to exhibit an excellent correlation in the incoming direction 2 (not illustrated).

This frequency distribution is generated by composite factors. The first of these composite factors is as follows: Namely, the occurrence number of the mutual interactions at the Compton-scattering event's position, i.e., the Compton-scattering electron's position, is a physical phenomenon which attenuates exponentially in accompaniment with the travelling of the gamma-ray flux as is the case with the single-pixel event. Although, as described earlier, the Compton-scattering electron's position does not necessarily coincide with the L position, this frequency distribution becomes the basic factor.

The second factor is as follows: Namely, consideration is given to the case where the L position indicates not the electron's position, but the photon's position, i.e. the case of 3C in FIG. 1. At this time, there exists an effect that the L position looks as if it returned by the amount of the LH vector 13 from the original electron's position which indicates the exponential distribution. The LH vector 13 is likely to be directed into the deeper direction, i.e. the same direction as the original gamma rays 3. Consequently, the L position is likely to be positioned onto the nearer side from the original electron's position. Namely, this effect operates in such a manner as to emphasize the exponential attenuation, i.e. in the case of 3C, the nearer side exhibiting the larger number of counts comes to exhibit even larger number of counts. This effect allows implementation of an even higher enhancement in the correlation of the L-position ideal frequency pattern E3 with the incoming direction 2.

Furthermore, the third of the composite factors is as follows: Namely, since the detector's size is finite, the Compton-scattering photon 12 is likely to drop off in the detection pixels 6 which are close to the detector's edge. Accordingly, there exists an effect that the L-position frequency becomes lowered. This effect speeds up the exponential attenuation in a direction, i.e. the same direction as the original gamma rays 3 like FIG. 4, in which the LH vector's lengthened probability is high. Consequently, this effect can operate in such a manner as to emphasize the exponential attenuation which is the basic factor.

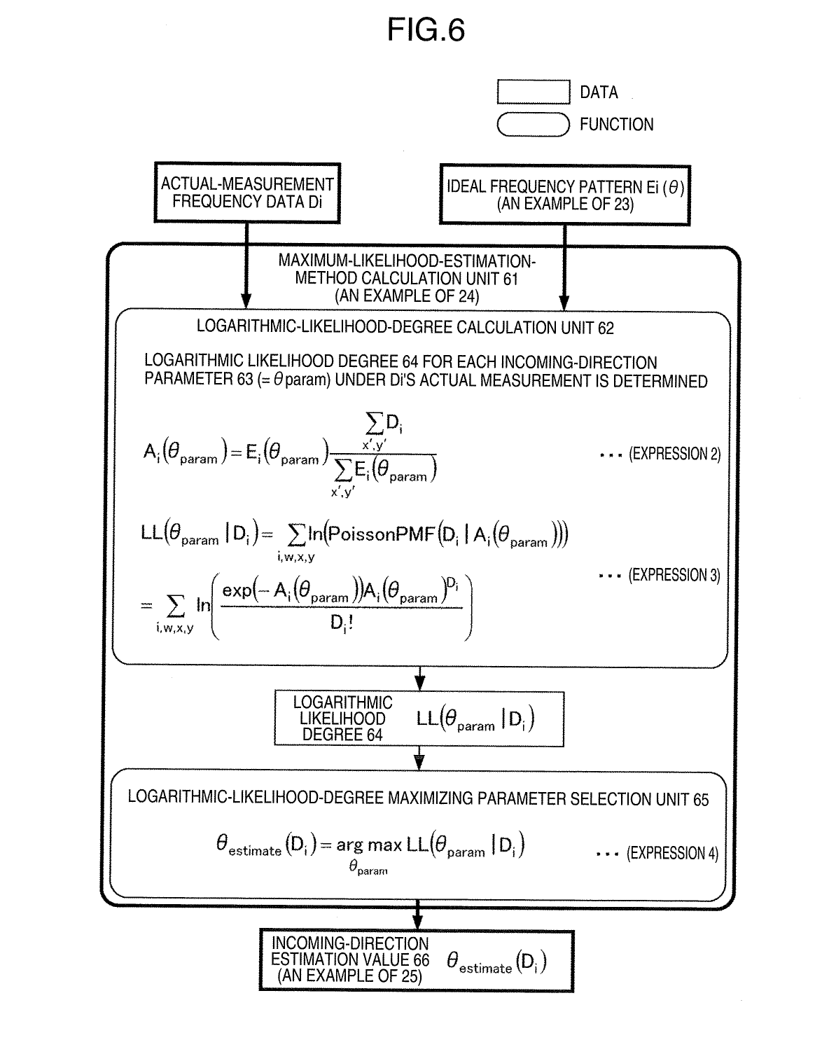

The second and third factors bring about a complexity that some kind of correlation is provided between the LH-vector ideal frequency pattern E2 and the L-position ideal frequency pattern E3. As will be described later in FIG. 6, however, the following fact has been confirmed: Namely, even if a simile addition is performed in the calculation of logarithmic likelihood degrees, a satisfactory estimation result can be obtained, and no specific bad influence has occurred.

From the above-described description, the use of the H position in substitution for the L position operates into an orientation of cancelling, i.e. planarizing, the exponential attenuation of the counts at the Compton-scattering electron's position which becomes the basic factor. Consequently, unlike the fact that the LH vector and the HL vector are equivalent to each other, the use of the L position is superior to the use of the H position. The H-position frequency data may also be used for the determination of the incoming direction 2, although it is inferior to the L position.

It corresponds to the following operation that the LH-vector ideal frequency pattern E2 and the L-position ideal frequency pattern E3 are used as described above: Namely, a four-dimensional bin of (xL, yL, xH, yH) is replaced by two pieces of two-dimensional bins of (xH-xL, yH-yL) and (xL, yL). This replacement allows the four-dimensional bin number to be tremendously decreased while permitting the dependence (information) on the incoming direction 2 to remain. Numerical values will be cited as its example. When the one-dimensional pixel number is equal to 8, the four-dimensional bin number 4096 (=8⁴) is decreased into the bin number 128 (=8²×2) of the two pieces of two-dimensional bins. Accordingly, the resultant ratio therebetween is equal to 1/32th. The calculation time and calculation resources, such as the memory, for making the estimation after the measurement are made equal to 1/32th by this ratio. Also, the cost, i.e., computer simulation time or measurement time, for preparing in advance the LH-vector ideal frequency pattern E2 and the L-position ideal frequency pattern E3 is similarly made equal to about 1/32th thereby.

Nevertheless, as long as an enormously large calculation cost can be managed, the above-described raw four-dimensional bin of (xL, yL, xH, yH), i.e., whose bin number is not decreased, is a satisfactory frequency distribution where the information on the incoming direction 2 is permitted to remain satisfactorily. The data and pattern resulting therefrom are defined as D4 and E4, respectively.

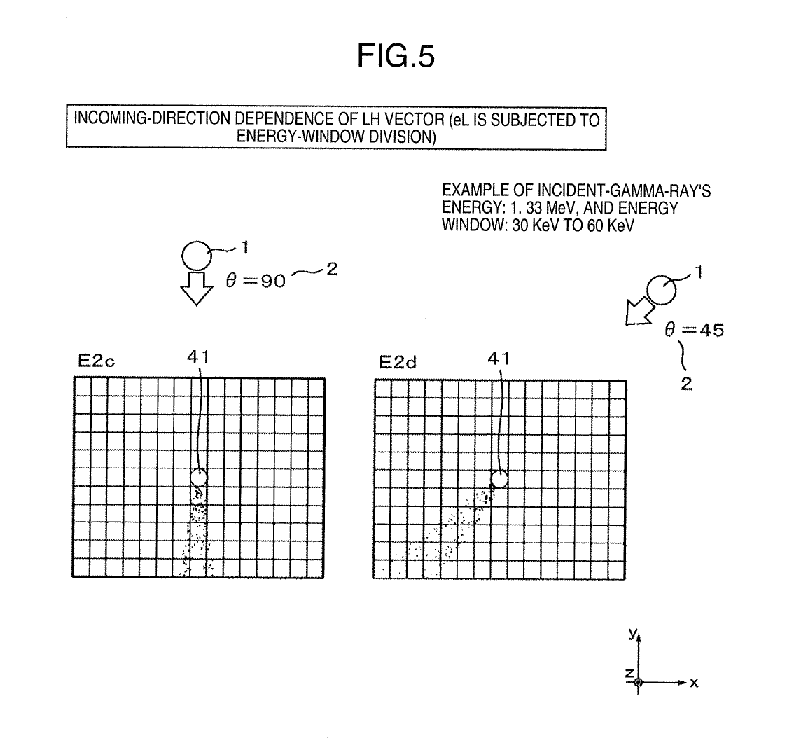

FIG. 5 illustrates the incoming-direction dependence of the LH vector, where eL is subjected to the energy-window division. FIG. 5 illustrates the LH-vector distributions which are acquired under the following conditions: Namely, at the irradiation time of the 1.33-MeV gamma ray, which is the same as the one in FIG. 4, the energy window with respect to eL, i.e. the lower-energy information of the two-pixel information, is set into the 30-keV to 60-keV energy range. Then, the relationship of the (Expressions 1) indicates that, in this energy range, there exists only the case, i.e. 3B in FIG. 1, where the Compton-scattering photon's angle a is shallow, and where the energy-assigned amount on the electron side is low. As E2, FIG. 5 illustrates E2c, which is obtained when the incoming direction 2 is equal to 90 degrees, and E2d, which is obtained when the incoming direction 2 is equal to 45 degrees. It is shown that the counts are localized into only the x-y ranges which are even narrower than those in FIG. 4.

In this way, depending on eL, the LH-vector ideal frequency pattern E2 exhibits the different distributions. Accordingly, consideration is given to the LH-vector ideal frequency pattern E2 [w], [x], [y] where w is separated as the energy-window number. This consideration makes it possible to indicate a distribution which is more characteristic of the incoming direction 2. This indication, however, is the trade-off with increases in the calculation amount after each measurement and the preparation time for the ideal frequency pattern Ei to be prepared in advance. Similarly, the L-position ideal frequency pattern E3 and the L-position actual-measurement frequency data D3 may also be subjected to the energy-window division.

FIG. 6 illustrates an incoming-direction estimation method where the maximum likelihood estimation method is used. The maximum likelihood estimation method is the following calculation methodology: Namely, first, there exist certain data d and a value w to be determined. Moreover, a realization probability distribution (i.e., likelihood degree) function P (d) of the data d is available in advance as a conditional probability distribution function P (d|ω) where a plurality of ω candidates are defined and used as its parameters ω. At this time, a parameter ω with respect to which P (d|ω) becomes its maximum is selected as the solution to be determined. The selection of the cause event ω based on the large-or-small relationship of the likelihood degrees like this is referred to as “estimation” in particular, and the cause event w which determines the characteristics of the distribution is referred to as “parameter in the statistical-field narrow meaning”.

A maximum-likelihood-estimation-method calculation unit 61, i.e. an example of 24, outputs an incoming-direction estimation value 66 by employing, as its inputs, the ideal frequency pattern Ei, i.e. an example of 23, prepared in advance, and certain actual-measurement frequency data Di. More simply, the calculation unit 61 can also be regarded as a unit which outputs the incoming-direction estimation value 66 in accordance with a manner of regarding the ideal frequency pattern Ei as being the constant values, and employing the actual-measurement frequency data Di as its inputs.

In the case of acquiring the actual-measurement frequency data Di, the measurement which is referred to as “each measurement” in FIG. 6 is not the detection of 1 count of 1 single/double-pixel event, but is an accumulation measurement over, e.g., 1 second for assuming the frequency distribution. Also, if the counting ratio is low, and if the measurement time for determining which level of energy should be selected and defined as the of-interest-gamma-ray's target is not negligible, it is advisable to store, as list data, (x, y, e, t) into the storage 22 in advance, and to acquire the counts whose number is large enough to determine the target energy, and after that, to get back to the start and to create the actual-measurement frequency data Di. If the types of radioisotopes which can exist are restricted into a few to a few tens of types, it is allowable to set M types falling into the plurality of of-interest-gamma-ray's energy ranges 17 from the beginning, and to acquire the actual-measurement frequency data Di for all of these M types. Basically, the respective of-interest-gamma-ray's energy ranges 17 can be addressed independently of each other. Accordingly, here, consideration is given to the case where there exists a single of-interest-gamma-ray's energy range 17 alone. Adjustment items associated therewith will be described later.

A logarithmic-likelihood-degree calculation unit 62 calculates a logarithmic likelihood degree 64 with respect to each incoming-direction parameter 63 (=θₚₐᵣₐₘ) which is hypothesized. Each frequency value of the actual-measurement frequency data Di follows the Poisson distribution. Providing the average-value count makes it possible to acquire the probability mass function (: PMF) of the Poisson distribution. Accordingly, the average-value pattern Ai [w] [x] [y] (θₚₐᵣₐₘ), which corresponds to the measurement amount of Di, is wish be created. In other words, when a certain θₚₐᵣₐₘ is hypothesized for each i and w, one piece of two-dimensional frequency distribution of A [x] [y] is wished to be created. A [x] [y] is adjusted into a small-number-of-counts number, which is equivalent to that of the actual-measurement frequency data D [x] [y], by multiplying E [x] [y] by a constant. Here, E [x] [y] is the frequency pattern which has the ideal-large-number-of-counts number. As a representative value of the count numbers of D [x] [y], consideration is given to their total value in the x and y directions. The consideration of this total value allows A [x] [y] to be acquired by the following (Expression 2), which causes ΣA and ΣD to coincide with each other:

$$\begin{matrix}[ MATH 2 ] & \\ {A}_{i} ( {θ}_{param} ) = {E}_{i} ( {θ}_{param} ) \frac{{\sum }_{{x}^{′} , {y}^{′}} {D}_{i}}{{\sum }_{{x}^{′} , {y}^{′}} {E}_{i} ( {θ}_{param} )} , \\ for each i , w & ( Expression 2 )\end{matrix}$$

Mathematically, each logarithmic likelihood degree 64 is given by the following (Expression 3): The description of the arguments w, x, and y is omitted except the positions of the summation notation. The range of numerical values retainable on a computer finds it impossible to express factorials completely (the upper-limit of the double-real-number type used often is equal to only 1. 7e308≈170!). The consideration of this fact makes it desirable to acquire the probability mass function of the Poisson distribution as logarithmic values from the internal structure. The value of Di which can be addressed is expanded by replacing the factorial value Di! by a proper logarithmic gamma function InGamma (Di+1). Also, if the distribution is extremely localized in the x direction, a bin whose frequency is equal to zero can exist even in the ideal frequency pattern Ei. Depending on a processing system, this bin gives rise to occurrence of undesirable phenomena such as an abnormal termination. Accordingly, it is advisable to provide exceptional processings such as skipping the calculation associated with this bin. This skip processing corresponds to the logarithmic likelihood degree+0, i.e., that the probability with which the bin's realization value occurs is equal to 100%. Consequently, from the Poisson PMF (D=0|A=0)=100%, this skip processing can be said to be an appropriate processing. There exists a possibility that, due to causes such as cosmic rays, a count is made in a place where the count must not be made originally. Considering the existence of this possibility, this skip processing may be extended and applied to the case where A [x] [y] is not strictly equal to zero (such as, e.g., skipping the calculation if A<0.01 count is found). This skip processing may also be a shore-up processing such as simply adding 0.01 to the entire average-value count.

$$\begin{matrix} [ MATH 3 ] & \\ \begin{matrix}LL ( {θ}_{param} \vert {D}_{i} ) = {\sum }_{i , w , x , y} ln ( PoissonPMF ( {D}_{i} \vert {A}_{i} ( {θ}_{param} ) ) ) \\ = {\sum }_{i , w , x , y} ln ( \frac{exp ( - {A}_{i} ( {θ}_{param} ) ) {{A}_{i} ( {θ}_{param} )}^{{D}_{i}}}{{D}_{i} !} )\end{matrix} & ( Expression 3 )\end{matrix}$$

The addition of logarithmic likelihood degrees is equivalent to the fact that simultaneous probabilities are represented by the product of the probabilities. D2 and D3 are not completely independent of each other, but have some kind of correlation therebetween. Here, however, the simple addition has been performed. Although this simple addition has a meaning of something like placing more importance on D2 and D3 rather than D1, no specific bad influence has occurred to the estimation. Also, it has been confirmed that the estimation performance resulting from the co-use of D2 and D3 is more satisfactory than the estimation performance resulting from D2 alone.

In a logarithmic-likelihood-degree maximizing parameter selection unit 65, from among the plurality of incoming-direction parameters 63 (θₚₐᵣₐₘ), a single incoming-direction parameter 63 (θₚₐᵣₐₘ) 1, which results in formation of the maximum logarithmic likelihood degree 64, is selected as the incoming-direction estimation value 66 (θₑₛₜᵢₘₐₜₑ).

$$\begin{matrix}[ MATH 4 ] & \\ {θ}_{estimate} ( {D}_{i} ) = {argmax}_{{θ}_{param}} LL ( {θ}_{param} \vert {D}_{i} ) & ( Expression 4 )\end{matrix}$$

From the above-described explanation, if a suitable count number is present in Di, the correct incoming direction 2, or a direction width including 2, can be acquired as the incoming-direction estimation value 66. If the count number is small, an erroneous direction may be estimated. However, if the ideal frequency pattern Ei has a continuity in the direction of the incoming angle 2, i.e., the ideal frequency pattern Ei in a certain incoming direction 2 is similar to Ei in an incoming direction 2 adjacent thereto, the estimation error becomes small. It is possible for the ideal frequency pattern Ei of the present invention to satisfy this continuity condition. For this purpose, it is advisable not to divide eL too minutely in the energy-window division of eL, so that the adjacent θₚₐᵣₐₘ and the portion where the counts are present are in contact with each other, or have an overlapped portion therebetween.

The use of the incoming-direction estimation value 66 (θₑₛₜᵢₘₐₜₑ) makes it possible to correct the estimation of the radiation amount, i.e., the dependence of the actually-measured total count on the incoming direction 2. A certain arbitrary single incoming direction 2, for example θ=0 degrees is set as being the criterion direction θ_{standard} of the sensitivity in advance. Then, letting the corrected total count be Ti, Ti is given by the following (Expression 5) concretely:

$$\begin{matrix}[ MATH 5 ] & \\ {T}_{i} = {\sum }_{w , x , y} {D}_{i} \frac{{\sum }_{w , x , y} {E}_{i} ( {θ}_{standard} )}{{\sum }_{w , x , y} {E}_{i} ( {θ}_{estimate} )} & ( Expression 5 )\end{matrix}$$

This (Expression 5) simply indicates the following operation: Namely, it has been recognized that, based on Ei prepared in advance, the sensitivity at the time of θ=45 degrees becomes equal to, e.g., 0.9 times as high as the sensitivity at the time of θ_{standard}=0 degrees. Accordingly, at the time of θₑₛₜᵢₘₐₜₑ=45 degrees, the total of the actually-measured counts Di is divided by 0.9. Both D2 and D3, and E2 and E3 are the same double-pixel events, and their respective total counts are strictly equal to each other. The independent total count Ti is of the two types of i=1 and 2.

As an example of the incoming-direction calculation unit 24 other than the maximum-likelihood-estimation-method calculation unit 61, it is conceivable to use, e.g., an image recognition for identifying analogous images. In this case, the conceivable incoming-direction calculation method is as follows: Namely, as is the case with the maximum likelihood estimation method, the ideal frequency pattern Ei is used as the actual-measurement-frequency-data-vs.-incoming-direction correspondence information 23. At this time, a single incoming-direction parameter 63, which results in formation of the ideal frequency pattern Ei, or the average-value pattern Ai, that is the most analogous to the actual-measurement frequency data Di, is selected and acquired as the incoming-direction calculation value 25. Here, the judgment on the analogy is made for each i and w, and using a methodology such as a pattern matching. A multi-dimensional pattern matching including i and w may also be used.

Still another example of the incoming-direction calculation unit 24 is as follows: Namely, even if an analytic inverse function θ=Function⁻¹ (Di, Ei) is not available, θ=f (Di) is made available and usable as some kind of empirical expression. For example, it is assumed that, in the distribution in FIG. 4, an angle is acquired at which there exists the center-of-gravity position of the counts. At this time, the center-of-gravity appears, with a high probability in accompaniment with an increase in the measurement amount, at the 180-degrees-symmetrical position with respect to the incoming direction 2. Consequently, a factor such as arctan, i.e. y center-of-gravity/x center-of-gravity, thereof may also be used. Also, differently, a fitting of the relative frequency Di'=g (θ) with respect to a θ change may also be used.

In this way, a plurality of implementation methods or units are conceivable for implementing the incoming-direction calculation unit 24. Consequently, what is of primary importance is not the incoming-direction calculation unit 24, but the selection of actually-measured data, for example Di, which exhibits a satisfactory correlation to a change in a value to be determined, i.e. incoming direction 2 in this case.

The reason why the maximum-likelihood-estimation-method calculation unit 61 is superior to the other incoming-direction calculation units 24 is the following point: Namely, in likelihood-degrees-utilized estimation methods such as the maximum likelihood estimation method, an indicator, which is referred to as “likelihood degrees” whose objective superposition is executable, is brought about into the simultaneous evaluation of the three pieces of actually-measured data, i.e. D1, D2 and D3, that have the mutually different dependence relationships with the incoming direction 2. Conversely speaking, no objective indicator exists in the superposition of θₒᵤₜₚᵤₜ (D1), θₒᵤₜₚᵤₜ (D2), and θₒᵤₜₚᵤₜ (D3), each of which is acquired as the incoming-direction calculation value 25 from each D1, D2, and D3 by using the other methodologies. As a result, this latter superposition is accompanied by some extent of discretion.

The calculation by this maximum-likelihood-estimation-method calculation unit 61, i.e. the logarithmic-likelihood-degree calculation unit 62 and logarithmic-likelihood-degree maximizing parameter selection unit 65, is performed in the measurement/calculation unit 9.

This calculation, however, may also be performed in the external device 27 by transferring the actual-measurement frequency data Di to the outside. Also, another maximum likelihood estimation method, which assumes an intermediate value between θ with respect to which the likelihood degree is the first largest and θ with respect to which the likelihood degree is the second largest, is conceivable as a not-simple modified maximum likelihood estimation method. Consequently, the broader designation for this methodology turns out to be “estimation based on likelihood degrees' large-or-small relationship”.

Hereinafter, the relative satisfactoriness/unsatisfactoriness of Di will be explained. As is shown from FIG. 4, the frequency-distribution structure of D2 is narrower in the θ direction with respect to the incoming direction 2 as compared with the frequency-distribution structure of D 1, and D3, in FIG. 3. Accordingly, D2 brings about the incoming-direction calculation value 25 which is more satisfactory, i.e. which is of small number of counts and correct. Since D4 includes D2 and D3, D4 is more satisfactory than D2. As described earlier, however, the calculation cost is in the different dimension and is enormously large. D1 and D3 are of the same count and of the same extent of performance empirically. If, however, the energy of the gamma ray becomes higher, the number of the single-pixel events decreases, and the number of the double-pixel events increases from physics of the gamma-ray's mutual interaction. Accordingly, it turns out that the per-measurement-time performance of D3 enhances. Summarizing the relative satisfactoriness/unsatisfactoriness results in the following Expression approximately:

D4(calculation cost is large)>D2>D1, D3.

Also, when a plurality of D is are used simultaneously, the relative satisfactoriness/unsatisfactoriness is given by the following Expression basically:

Da & Db≧Da, Db

, where a, b is an arbitrary i in 1 to 3.

D4 is not independent of D2 and D3, but includes D2 and D3. Consequently, the above-described Expression is inapplicable to D4. D4 has its meaning only in the simultaneous evaluation with D1. Concretely, the following Expressions hold: D4 & D1≧D4>D1, and D4 & D2≈D4 & D3 D4.

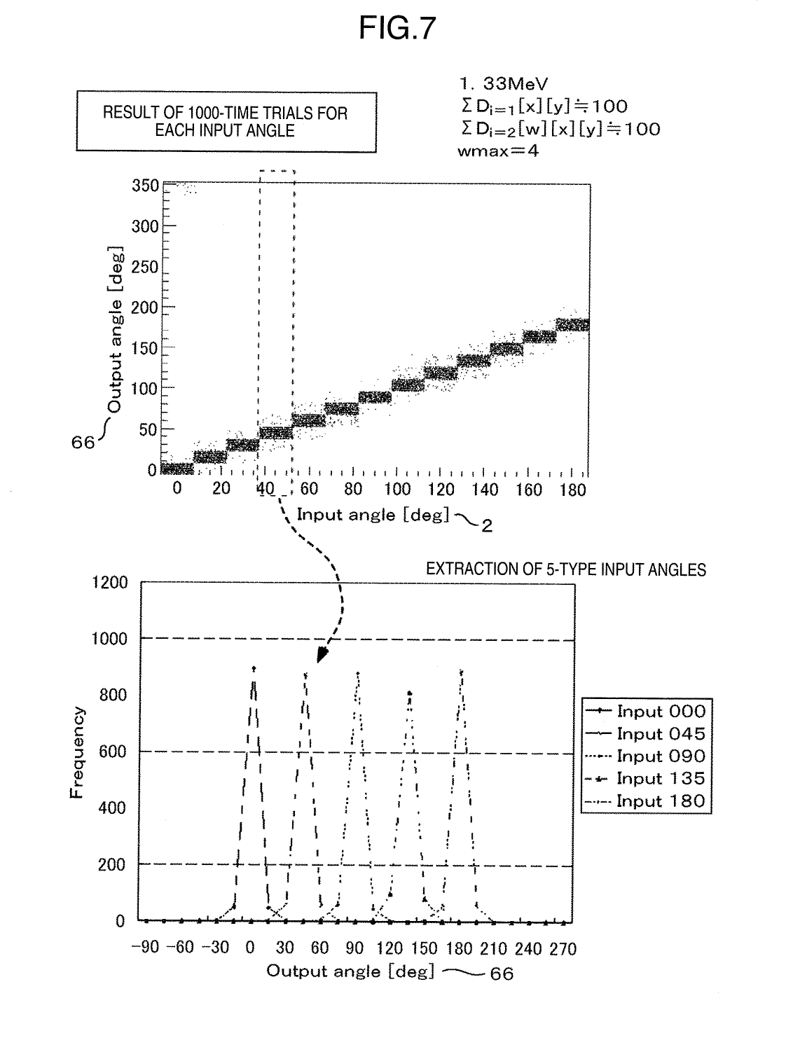

FIG. 7 illustrates a sample of the incoming-direction estimation result which is acquired based on the maximum likelihood estimation method where the actual-measurement frequency data Di and the ideal frequency pattern Ei are employed. This sample is the result acquired in the case of D1 & D2 & D3. Also, this sample is the result acquired when 1000-time maximum-likelihood-estimation-method trials for each of 13-type true incoming directions 2 are performed under the following conditions: Namely, under a certain detector's geometry, i.e. the representative size of the detector 10 is equal to 6 cm, and the bright/dark-color-concentration emphasizing member 31 is present, prototyped on a computer, 1.33-MeV gamma-ray's energy, 15-degrees-Ei's directions-parameter increment, certain 4 energy-window divisions subjected to eL, and about a 100-count Di's count number for both the single-pixel event and the double-pixel event. FIG. 7 above is a two-dimensional histogram where the transverse axis denotes the true incoming directions 2, and the longitudinal axis denotes the incoming-direction estimation value 66. This histogram shows that, even under the severe count condition of about the 100-count single-pixel event, the correct direction, i.e. the incoming direction 2, or its adjacent direction has been successfully acquired as the incoming-direction estimation value 66 on each of all of the trials. Also, this histogram shows that this result's sample exhibits a preferable characteristic that the dependence of the resolution, i.e. the variation in the incoming-direction estimation value 66, on the difference in the true incoming directions 2 is significantly small. As the calculation cost, the data capacity needed for retaining the ideal frequency pattern Ei is equal to a few hundreds of kBs, the data capacity of the actual-measurement frequency data Di is equal to a few tens of kBs, and the time needed for executing the 1-trial maximum likelihood estimation method is equal to a few tens of milliseconds using a common PC. These values can be said to be small enough. Consequently, the parallel processing for a plurality of of-interest-gamma-ray's energy ranges 17 is also easy to execute.

FIG. 7 below is a one-dimensional histogram of the incoming-direction estimation value 66 which is extracted with respect to 5 points of the true incoming directions 2. This histogram is illustrated in order to describe the height information in detail. The right-answer ratio given by the distribution of this histogram has been found to be about 80% to 90%. Moreover, the remaining areas exist in both of the adjacent directions in a basically uniform manner. Accordingly, this distribution is a natural and satisfactory distribution. A slight amount of difference found in the height has been grasped as an individuality of the detector's geometry, i.e. the sensitive-volume longitudinal directions are 90 degrees and 270 degrees, and the bright/dark-color-concentration emphasizing member 31 is present only at 0 degrees, in the present embodiment. Also, naturally, it has been confirmed that there exists a preferable characteristic that the right-answer ratio will transition to 100% when the count is increased further.

As having been described above, the methodology which the measurement/calculation unit 9 employs in order to calculate the incoming direction is as follows: First, after defining respective incoming directions as respective incoming-direction parameters, the unit 9 calculates the realization probabilities, i.e. likelihood degrees or logarithmic likelihood degrees, of measurement data. Moreover, the unit 9 estimates the incoming direction from the large-or-small relationship of these likelihood degrees or logarithmic likelihood degrees with respect to the respective incoming-direction parameters. This methodology makes it possible to acquire information about the certainty of this estimation.

### Embodiment 3

As a third embodiment, the explanation will be given below concerning the extension of the present invention to the two-dimensional direction, i.e. latitude and longitude.

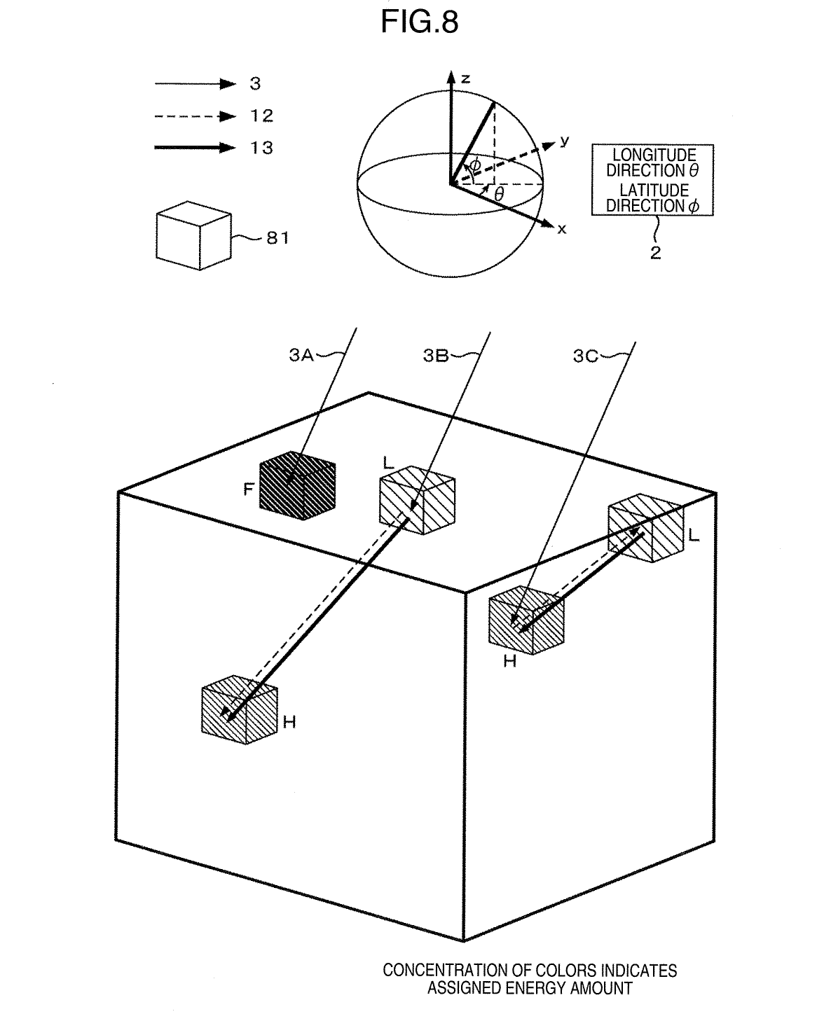

FIG. 8 illustrates the overview of the incident-gamma-ray's direction detecting apparatus and the used-data definition associated therewith in 3D. Now, consideration is given to a case where there is provided the space resolution in the z direction, which has been neglected in the second embodiment. When each detection pixel 6 has its pixel size 81, as is illustrated in the drawing, each F position, each LH vector 13, and each L position are created only by adding the z information to the foregoing definitions, and thus are basically the same. The incoming direction 2 is extended from the one value of θ to two values of θ and φ. The definition of the longitude direction θ is basically the same as in the first embodiment, but φ is newly defined as the latitude direction. The extension of z and φ is also performed similarly with respect to each step in FIG. 2. Under an extension like this, it becomes possible to satisfactorily describe the changes in Ei and Di with respect to a change in the φ direction. Accordingly, it becomes possible to estimate the combination θ and φ, although this estimation is the trade-off with an increase in the calculation amount.

### Embodiment 4

As a configuration item which is common to the first, second, and third embodiments, the explanation will be given below concerning an embodiment of the interface unit.

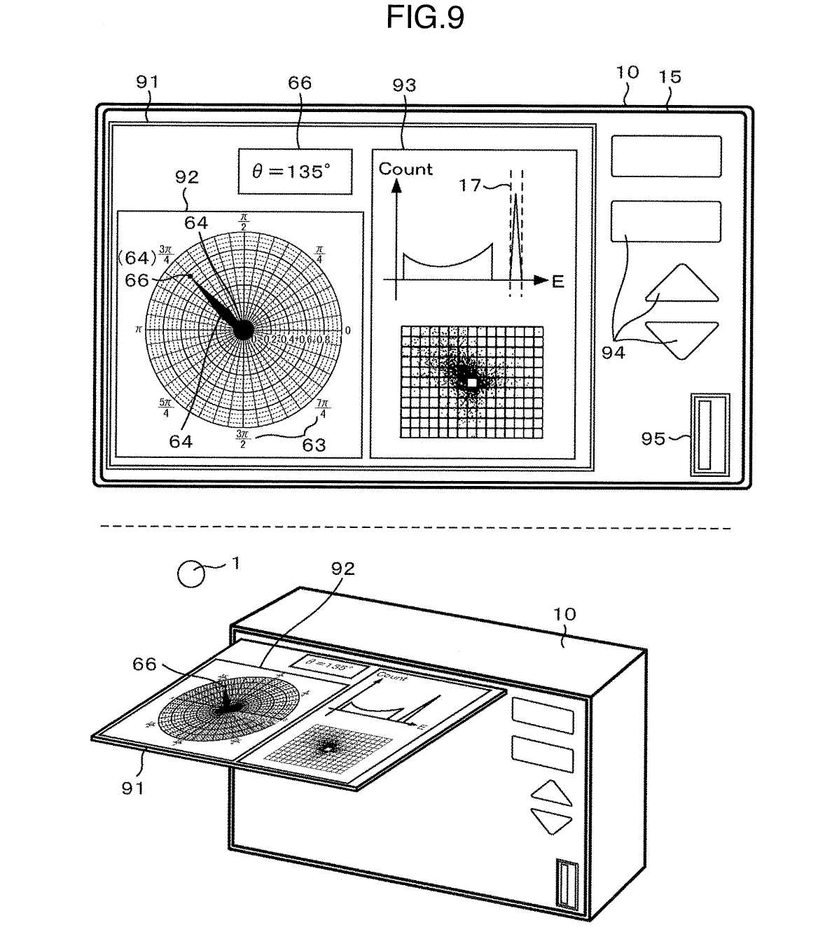

FIG. 9 illustrates a schematic diagram of the interface unit. The detector 10 includes the interface panel 15 on its rear surface, thereby making it possible to perform the following information input/output: The display unit 91 performs a user-dedicated information output, using an appliance such as a liquid-crystal panel. The display unit 91 displays not only the incoming-direction estimation value 66, but also the logarithmic likelihood degrees 64 with respect to the respective incoming-direction parameters 63 which have become the raw material for the estimation. More specifically, the display unit 91 polar-coordinate-displays the logarithmic likelihood degrees 64 on a logarithmic-likelihood-degree display unit 92 in such a manner that the degrees 64 are subjected to a polar-coordinate transformation in a manner of being normalized by, e.g., their maximum value. This polar-coordinate display of the degrees 64 makes it possible to acquire the information about the certainty of this estimation. For example, in the estimation based on an exceedingly small number of counts, the logarithmic likelihood degrees 64 exhibit a wide, i.e. unsatisfactory, distribution, such as having high values in the plurality of incoming-direction parameters 63. In the estimation based on an exceedingly large number of counts, however, the logarithmic likelihood degrees 64 become overwhelmingly large in a single incoming-direction parameter 63, thereby exhibiting a narrow, i.e., satisfactory, distribution. It is also allowable to reinforce the information about the certainty of the estimation in accordance with the following way: Namely, the logarithmic likelihood degrees 64, which are under a more severe condition for a partial constituent of the i and w direction out of the actual-measurement frequency data Di, are displayed on this logarithmic-likelihood-degree display unit 92 in a manner of being superimposed on each other in accompaniment with, e.g., different colors. This reinforcement of the above-described information plays a useful role in judging a balance point of the trade-off between the measurement time and the reliability, which are not necessarily uniform at whatever radiation-detecting site. A processing similar to this reinforcement may also be performed automatically inside the unit.

Also, the direction of the detector 10 is required to be maintained at a constant one while the measurement is underway. Accordingly, this direction cannot be changed freely then. As illustrated in FIG. 8 below, however, the display unit 91 is connected to the detector 10 by a connection unit which is capable of changing the angle of the display unit 91 with reference to the detector 10. This connection makes it possible to cause the logarithmic-likelihood-degree display unit 92 and the actual azimuth to coincide with each other, thereby allowing implementation of the intuitive grasping of the incoming-direction estimation value 66. Incidentally, the explanation has been given above on the basis of the logarithmic-likelihood-degree display unit 92. The display unit 91, however, is not limited to the logarithmic-likelihood-degree display. Namely, the display unit 91 may also be some other display, as long as it is a display for indicating the radiation's incoming direction. Also, the radiation's direction detecting apparatuses and methods are not limited to the ones explained in the first to third embodiments. Namely, the employment of the radiation's direction detecting method based on such appliances as the Compton camera also allows implementation of the intuitive grasping of the radiation's incoming direction similarly. Such parts as wing screw and ball joint are employable as the connection unit. Also, in the case of the two-dimensional-screen-based direction display for displaying the three-dimensional measurement on the radiation's incoming direction, the alignment of the two-dimensional-screen's flat plane with the radiation's incoming direction makes it easy to perform the intuitive grasping of the radiation's incoming direction. In this case, it is made possible to permit the operator to align the two-dimensional-screen's flat plane with the radiation's incoming direction by calculating and displaying an angle of the two-dimensional screen at which the radiation's incoming direction calculated and the two-dimensional-screen's flat plane coincide with each other. An angle sensor is set up on the connection unit, and the two-dimensional screen is displaced. Then, when the flat plane coincides with the radiation's incoming direction, a coincidence-occurrence-indicating screen display is given. This notice permits the operator to shorten a time needed for the flat-plane-aligning operation.

In this way, there is provided the radiation's direction detecting apparatus, including the plurality of detection pixels for detecting the radiations, the measurement/calculation unit which measures the radiations using the plurality of detection pixels, and calculating a radiation's incoming direction, the display unit which displays the radiation's incoming direction, and the connection unit which changes the angle of the display unit into an arbitrary position relative to the detecting apparatus's main body. This radiation's direction detecting apparatus allows implementation of the intuitive grasping of the radiation's incoming direction.

The display unit 91 further includes a general-purpose display unit 93. The general-purpose display unit 93 allows operations, such as specification of the of-interest-gamma-ray's energy range 17, or the nuclear species of the gamma-ray source 1, to be executed from a button-operating unit 94, or the touch-panel-function-equipped display unit 91. The general-purpose display unit 93 is allowed to display the actual-measurement frequency data Di and the ideal frequency pattern Ei using such indications as different colors or plot types, i.e. contour lines and scatter plot.

The input/output unit 95, i.e. wired connector or wireless communications unit, allows the transfer of the ideal frequency pattern Ei, which is prepared in advance in a representative detector outside, from the external device 27 to the detector 10. Also, the unit 95 allows the transfer of the actual-measurement frequency data Di and the raw data (x, y, z, e, t) from the N unit of detectors 10 to the external device 27. Also, the ideal frequency pattern Ei can be prepared by the single unit of detector 10 from the long-time measurement result.

The above-described respective embodiments can be carried out in such a manner that the following points are taken into consideration:

An adjustment item is as follows: Namely, when a plurality of of-interest-gamma-ray's energy ranges 17 are addressed simultaneously, the scattered radiation originating from a high-energy photon exerts its influence on the low-energy-side ideal frequency pattern Ei. Since this influence can be evaluated in advance, it is advisable to add this influence into Ei.

Also, in many cases, a radioisotope, i.e., the gamma-ray source 1, generates a plurality of different-energy gamma rays with a determined ratio actually, and thus the second constituent cannot be neglected. At this time, the following processing is allowable, for example: Namely, two or more of-interest-gamma-ray's energy ranges 17 are assigned to a single radioisotope nuclear species. Moreover, the summation of the logarithmic likelihood degrees is assumed in the index-M direction of these of-interest-gamma-ray's energy ranges 17 by using two logarithmic-likelihood-degree calculation units 62.

The ideal frequency pattern Ei is influenced by a case where the distribution of a physical substance outside the detector 10 exhibits an angle dependence. An example of this case is that a human body exists only on the rear-surface side of the detector 10. Consequently, it is desirable to make it possible to perform the corresponding correction with respect to its typical cases, such as the human body (i.e., user) and open/close of the interface panel.

In the above-described embodiments, the explanation has been given regarding the example where the above-described technology is applied to the following gamma-ray's direction detecting apparatus: Namely, in this apparatus, the detection pixels adjacent to each other are deployed such that the detection pixels are densely packed with no clearance set up therebetween. The above-described technology, however, is also applicable to a gamma-ray's direction detecting apparatus where the detection pixels adjacent to each other are deployed with a clearance set up therebetween. For example, this technology is also applicable to such apparatuses as the Compton camera where the two-layer detectors are deployed with a clearance set up therebetween. The detection based on the frequency distribution is used for the processing performed by the gamma-ray's direction detecting apparatus where the detection pixels are deployed with the clearance set up therebetween. This scheme makes it possible to acquire the radiation's incoming direction information without the insensitive direction.

Incidentally, the present invention is not limited to the above-described embodiments, but includes various types of modified embodiments. For example, the above-described embodiments have been explained in detail in order to make the present invention easy to understand. Namely, the above-described embodiments are not necessarily limited to embodiments which are equipped with all of the configurations explained. Also, it is possible to add the configuration of another embodiment to that of a certain embodiment. Also, it is possible to perform the addition/deletion/replacement of another embodiment with respect to a partial configuration of each embodiment other than that.

Also, a partial or the entire configuration of the above-described configuration of each embodiment may be configured by using hardware, or may be so configured as to be implemented by processor's executing corresponding programs. Also, the line-based description for indicating the flows of the controls and information indicates the flows which are conceivable as being necessary for the explanation. Namely, the line-based description does not necessarily indicate the flows of all of the controls and information on the product. It is also allowable to consider that, actually, almost all of the configurations are mutually connected to each other.

### INDUSTRIAL APPLICABILITY

The present invention is applicable to gamma-ray detecting detectors.

### [Reference Signs List]

1 gamma-ray source
2 incoming direction (θ, or combination of (θ, φ))
3 gamma rays
4 chassis
5 supporting members
6 detection pixels
7 substrate
8 connector
9 measurement/calculation unit
10 incident-gamma-ray's direction detecting apparatus (or simply, detector),
12 Compton-scattering photon
13 LH vector
15 interface panel
21 gamma-ray detecting unit
22 storage
23 correspondence information
24 incoming-direction calculation unit
25 incoming-direction calculation value
26 arbitrary information
27 external device
31 bright/dark-color-concentration emphasizing member
32 shadow-originated small-number-of-counts portion
41 L-position start point
42 start-points-aligned LH-vector end points
61 maximum-likelihood-estimation-method calculation unit
62 logarithmic-likelihood-degree calculation unit
63 incoming-direction parameters
64 logarithmic likelihood degrees
65 logarithmic-likelihood-degree maximizing parameter selection unit
66 incoming-direction estimation value
81 pixel size
91 display unit
92 logarithmic-likelihood-degree display unit
93 general-purpose display unit
94 button-operating unit
95 input/output unit
D1 F-position actual-measurement frequency data
D2 LH-vector actual-measurement frequency data
D3 L-position actual-measurement frequency data
Di actual-measurement frequency data
E1 F-position ideal frequency pattern
E2 LH-vector ideal frequency pattern
E3 L-position ideal frequency pattern
Ei ideal frequency pattern
E1a F-position frequency pattern at θ=90 degrees
E1b F-position frequency pattern at θ=45 degrees
E1c F-position frequency pattern at θ=90 degrees (bright/dark-color-concentration emphasizing member is present)
E1d F-position frequency pattern at θ=45 degrees (bright/dark-color-concentration emphasizing member is present)
E2a LH-vector frequency pattern at θ=90 degrees
E2b LH-vector frequency pattern at θ=45 degrees
E2c LH-vector frequency pattern at θ=90 degrees (eL window is present)
E2d LH-vector frequency pattern at θ=45 degrees (eL window is present)

1. A gamma-ray's direction detecting apparatus, comprising:
a plurality of detection pixels for detecting gamma rays;
a memory device which memorizes a correspondence relationship in advance, said correspondence relationship being established for indicating, with respect to predetermined gamma-ray's incoming directions, what kind of actual-measurement frequency data should be acquired using said plurality of detection pixels; and
a measurement/calculation unit which measures said gamma-ray's actual-measurement frequency data detected using said plurality of detection pixels, and calculates a gamma-ray's incoming direction by using said actual-measurement frequency data and said correspondence relationship memorized into said memory device.

2. The gamma-ray's direction detecting apparatus according to claim 1, wherein
frequency data on inter-two-points relative positions is used as said actual-measurement frequency data, said inter-two-points relative positions being ranked by an energy-assigned amount into each detection pixel in a double-pixel event.

3. The gamma-ray's direction detecting apparatus according to claim 1, wherein
frequency data on a total-energy absorption position in a single-pixel event is used as said actual-measurement frequency data.

4. The gamma-ray's direction detecting apparatus according to claim 1, wherein
frequency data on a single-point position is used as said actual-measurement frequency data, said single-point position being ranked by an energy-assigned amount into each detection pixel in a double-pixel event.

5. The gamma-ray's direction detecting apparatus according to claim 1, wherein
said gamma-ray's direction detecting apparatus uses, as said actual-measurement frequency data, a combination of at least two or more whatever frequency data of
frequency data on a total-energy absorption position in a single-pixel event,
frequency data on inter-two-points relative positions ranked by an energy-assigned amount into each detection pixel in a double-pixel event, and
frequency data on a single-point position ranked by said energy-assigned amount into each detection pixel in said double-pixel event.

6. The gamma-ray's direction detecting apparatus according to claim 5, wherein
a correspondence relationship used as said correspondence relationship between said measurement data and said incoming directions corresponds to said measurement data used, and is established as a result of a sufficient counting for each incoming-direction parameter,
an incoming-direction calculating methodology used by said measurement/calculation unit comprising the steps of:
defining each of said incoming directions as each incoming-direction parameter;
calculating realization probabilities of said measurement data, said realization probabilities being likelihood degrees or logarithmic likelihood degrees; and
estimating said incoming direction from a large-or-small relationship of said likelihood degrees or logarithmic likelihood degrees with respect to each incoming-direction parameter.

7. The gamma-ray's direction detecting apparatus according to claim 6, wherein
said likelihood degrees or logarithmic likelihood degrees are polar-coordinate-displayed by being subjected to a polar-coordinate transformation, each of said incoming directions being defined as each incoming-direction parameter with respect to said likelihood degrees or logarithmic likelihood degrees.

8. The gamma-ray's direction detecting apparatus according to claim 7, further comprising:
a connection unit which changes angle of a display unit into an arbitrary position relative to said detecting apparatus's main body, said likelihood degrees or logarithmic likelihood degrees being polar-coordinate-displayed by said display unit, each of said incoming directions being defined as each incoming-direction parameter with respect to said likelihood degrees or logarithmic likelihood degrees.

9. The gamma-ray's direction detecting apparatus according to claim 1, wherein
said detection pixels are deployed such that said detection pixels are densely packed with no clearance set up therebetween, said detection pixels being adjacent to each other.

10. The gamma-ray's direction detecting apparatus according to claim 1, wherein
said detection pixels are deployed with a clearance set up therebetween, said detection pixels being adjacent to each other.

11. A gamma-ray's direction detecting method, comprising the steps of:
by a gamma-ray's direction detecting apparatus being so designed as to memorize a correspondence relationship in advance, said correspondence relationship being established for indicating, with respect to predetermined gamma-ray's incoming directions, what kind of actual-measurement frequency data should be acquired using said plurality of detection pixels for detecting gamma rays,
detecting gamma rays using a plurality of detection pixels; and
measuring gamma-ray's actual-measurement frequency data detected using said plurality of detection pixels, and calculating a gamma-ray's incoming direction by using said actual-measurement frequency data and a correspondence relationship memorized into a memory device.

12. The gamma-ray's direction detecting method according to claim 11, wherein
frequency data on inter-two-points relative positions is used as said actual-measurement frequency data, said inter-two-points relative positions being ranked by an energy-assigned amount into each detection pixel in a double-pixel event.

13. The gamma-ray's direction detecting method according to claim 11, wherein
frequency data on a total-energy absorption position in a single-pixel event is used as said actual-measurement frequency data.

14. The gamma-ray's direction detecting method according to claim 11, wherein
frequency data on a single-point position is used as said actual-measurement frequency data, said single-point position being ranked by an energy-assigned amount into each detection pixel in a double-pixel event.

15. A gamma-ray's direction detecting apparatus, comprising:
a plurality of detection pixels which detects gamma rays;
a measurement/calculation unit which measures said gamma rays using said plurality of detection pixels, and calculates a gamma-ray's incoming direction;
a display unit which displays said gamma-ray's incoming direction; and
a connection unit which changes angle of said display unit into an arbitrary position relative to said detecting apparatus's main body.
